(19) United States
(12) Patent Application Publication
(10) Pub. No.: US 2005/0114327 A1
(43) Pub. Date: May 26, 2005

(54) Question-answering system and question-answering processing method

(75) Inventors: Tadahiko Kumamoto, Tokyo (JP); Masaki Murata, Tokyo (JP)

Correspondence Address: STAAS & HALSEY LLP, SUITE 700, 1201 NEW YORK AVENUE, N.W., WASHINGTON, DC, 20005, US

(73) Assignee: National Institute of Information and Communications Technology, Tokyo (JP)

(21) Appl. No.: 10/989,485

(22) Filed: Nov. 17, 2004

(30) Foreign Application Priority Data
Nov. 21, 2003 (JP) 2003/391938

(51) Int. Cl. G06F 7/00

(52) U.S. Cl. 707/3

(57) ABSTRACT

A question sentence input part of question-answering system inputs a question sentence presented in a natural language. A document retrieval part of the system extracts a keyword from the question sentence and retrieves and extracts the document data including the keyword from a document database. An answer candidate extracting part of the system extracts a language presentation possibly becoming the answer as an answer candidate from the retrieved and extracted document data. An answer type determination part of the system determines an answer type of the answer candidate. An answer table output part of the system classifies the answer candidates by answer type and outputs an answer table listing all or part of the answer candidates having a predetermined evaluation or greater for each answer type in a table format.

### CROSS-REFERENCE TO RELATED APPLICATIONS

The present application claims the benefit of patent application number 2003-391938 filed in Japan on Nov. 21st, 2003, the subject matter of which is hereby incorporated herein by reference.

### BACKGROUND OF THE INVENTION

1. Field of the Invention

The present invention relates to a question-answering system for outputting an answer for a question sentence expressed in a natural language, as one of the natural language processing systems using a computer.

2. Description of the Related Art

A question-answering system outputs an answer itself if a question sentence expressed in a natural language is inputted. For example, if a question “In which part of the brain a symptom of Parkinson's disease is concerned with death of cells?” is inputted, a sentence describing “Parkinson's disease is caused when melanocyte residing in substantia nigra of mesencephalon is denatured and dopamine of neurotransmitter produced within nigra cells disappears.” is searched from a large amount of electronic text including Web pages, newspaper items, and encyclopedia. Then, a proper answer of “substantia nigra” is outputted based on the searched sentence.

The question-answering system retrieves the answer not from the logical formula or database, but from a common sentence (text data) described in the natural language, and makes use of a large amount of existent document data. Also, the question-answering system outputs the answer itself, unlike an information retrieval system in which the user himself/herself needs to search the answer from articles retrieved by a keyword. Therefore, the user can acquire the information about the answer more rapidly. In this way, the question-answering system is useful, and expected to be implemented as the user-friendly and practical system.

A typical question-answering system largely comprises of three processing means, namely, an answer presentation estimation processing means, a document retrieval processing means, and an answer extraction processing means (refer to cited documents 1 and 2).

The answer presentation estimation processing means estimates the answer presentation, based on the presentation of an interrogative pronoun in the input question sentence. The answer presentation is a pattern of language presentation for a desired answer, and may be an answer type based on the meaning of language presentation possibly becoming the answer, or an answer presentation type based on the notation of language presentation possibly becoming the answer. The question-answering system estimates the answer type of the answer for the input question sentence by referring to the correspondence relation indicating which language presentation of question sentence requires which answer presentation. For example, when the input question sentence is “What is the area of Japan?”, the question-answering system estimates that the answer type is “numerical presentation” from the presentation of “what” in the question sentence by referring to the predetermined correspondence relation. Also, when the question sentence is “Who is the prime minister of Japan?”, the answer type is estimated to be “specific noun (person's name)” from the presentation of “who” in the question sentence.

The document retrieval processing means takes a keyword out of the question sentence, and retrieves the group of document data to be retrieved for the answer, using the keyword, and extracts the document data in which the answer is supposedly described. For example, when the input question sentence is “Where is the capital of Japan?”, the question-answering system extracts “Japan” and “capital” as the keywords from the question sentence, and retrieves the document data including the keywords “Japan” and “capital” from the group of document data to be retrieved.

The answer extraction processing means extracts the language presentation conforming to the estimated answer type, as the answer, from the document data including the keyword extracted by the document retrieval process, and outputs it as the answer. The question-answering system extracts the language presentation “Tokyo” conforming to the answer type “specific noun (place name)” estimated by the answer presentation estimation process from the document data including the keywords “Japan” and “capital” retrieved by the document retrieval process, for example.

Through the above processes, the question-answering system outputs the answer “Tokyo” for the question sentence “Where is the capital of Japan?”.

[Document 1: Eisaku Maeda “Question-Answering in Pattern Recognition/Statistical Learning” from the material for a seminar by Committee of Language Recognition and Communication in The Institute of Electronics, Information and Communication Engineers, Jan. 27 (2003), P29-64]

[Document 2: Masaki Murata, Masao Utiyama, and Hitoshi Isahara, “A Question-Answering System Using Unit Estimation and Probabilistic Near-Terms IR”, National Institute of Informatics NTCIR Workshop 3 Meeting QAC1, 2002.10.8]

As described above, the conventional question-answering system extracts the language presentation possibly becoming the answer as the answer candidate from the retrieved document data and determines the answer type for each extracted answer candidate. And it grants a high evaluation to the answer candidate determined to be the answer type identical or similar to the answer type estimated from the question sentence, and principally outputs the answer candidate belonging to the same answer type and having high evaluation as the answer.

However, the answer type estimated by the answer presentation estimation process is not always correct. Therefore, when the answer type is falsely estimated, the reference contains an error in evaluating the answer candidate in the answer extraction process, resulting in lower precision of the answer extraction process.

Also, for the user of the question-answering system, when the answer type output by the question-answering system is not correct, it is expedient that the answer is output in the format allowing the user to refer to the answer candidate determined to be another answer type. Especially in view of the practical use, the question-answering system that outputs the answer candidates for a plurality of answer types is very friendly for the user.

### SUMMARY OF THE INVENTION

An object of the present invention is to provide a question-answering system and a question-answering processing method capable of outputting the answers classified by answer type in a table format so that the user may check with the eyes the answers outputted by the question-answering system for each answer type.

In order to accomplish the above object, the invention provides a question-answering system for inputting the question sentence data expressed in a natural language and outputting an answer for the question sentence data to be retrieved from a group of document data, wherein the answers classified by answer type are outputted in a table format with each answer type as a heading item.

The invention provides a question-answering system for inputting the question sentence data expressed in a natural language and outputting an answer for the question sentence data from a group of document data to be retrieved for the answer, comprising document retrieval means for extracting a keyword from the input question sentence data and retrieving and extracting the document data including the keyword from the group of document data, answer candidate extracting means for extracting a language presentation possibly becoming the answer as an answer candidate from the document data, answer type determination means for storing predetermined answer types for classifying the answer candidates and determining of which answer type the answer candidate is, and answer table output means for classifying the answer candidates by answer type, and outputting the answer table data in a table format in which all or part of the answer candidates are arranged with the answer type as a heading item for each answer type.

In this invention, if the question sentence data expressed in the natural language is inputted, the keyword is extracted from the input question sentence data, and the document data including the keyword is retrieved and extracted from the group of document data such as news item data or encyclopedia data to be retrieved for the answer. And the language presentation possibly becoming the answer is extracted as the answer candidate from the retrieved and extracted document data, the predetermined answer types for classifying the answer candidates are stored, and the answer type of the answer candidate is determined. For example, the answer type indicating the meaning pattern for the language presentation of answer candidate or the answer presentation type indicating the inscribed pattern for the language presentation of answer candidate is stored, and the answer type of the answer candidate is determined. And the extracted answer candidates are classified by answer type, and the answer table data listing in table format all or part of the answer candidates having a predetermined evaluation or greater for each answer type with the answer type as the heading item is outputted. Thereby, the user knowing the answer type for the answer knows the answer from the answer table data in which the answer types are arranged in predetermined order by seeing the item of necessary answer type, and also refers to the answers of other answer types.

Further, the invention provides the question-answering system with the above constitution, further comprising answer type estimation means for analyzing the language presentation of the question sentence data and estimating a degree of confidence that the answer for the question sentence data is predetermined answer type, wherein the answer table output means creates the answer table data in which the answer types are arranged in descending order of the degree of confidence.

In the invention, the degree of confidence that the answer is the predetermined answer type is estimated from the language presentation of the question sentence data, and the answer table data in which the answer types are arranged in descending order of the degree of confidence is created and outputted. Thereby, the item of answer type estimated to be most likely is arranged at the beginning in the answer table data, whereby the user knows the answer by seeing the item of answer type at the beginning in the answer table and refers to the answers of other answer types.

Also, the invention provides a question-answering system for inputting the question sentence data expressed in a natural language and outputting an answer for the question sentence data from a group of document data to be retrieved for the answer, comprising answer type input means for inputting an answer type of the answer for the question sentence data, document retrieval means for extracting a keyword from the input question sentence data and retrieving and extracting the document data including the keyword from the group of document data, answer candidate extracting means for extracting a language presentation possibly becoming the answer as an answer candidate from the document data, answer type determination means for storing predetermined answer types for classifying the answer candidates and determining of which answer type the answer candidate is, and answer table output means for classifying the answer candidates by answer type, and outputting the answer table data in a table format listing all or part of the answer candidates with the answer type as a heading item for each answer type and with the input answer type at the beginning item.

In this invention, the answer type of the answer for the question sentence data is inputted. Also, the keyword is extracted from the input question sentence data, the document data including the keyword is retrieved and extracted from the group of document data, and the language presentation possibly becoming the answer is extracted as the answer candidate from the document data. And the predetermined answer types for classifying the answer candidates are stored, and the answer type of the answer candidate is determined. Thereafter, the answer candidates are classified by answer type, and the answer table data in a table format in which all or part of the answer candidates are arranged with the answer type as a heading item for each answer type and the input answer type is the beginning item is outputted.

Thereby, the item of answer type inputted by the user is arranged at the beginning in the answer table data, whereby the user knows the answer by seeing the item of answer type at the beginning in the answer table and refers to the answers of other answer types.

In this invention, the answer type of the answer candidate extracted from the document data retrieved in the document retrieval process is determined according to the predetermined rules, the answer candidates are classified by answer type, and the answer table in the table format of listing the answer candidates for each of the answer types arranged in the predetermined order is outputted.

Thereby, even in the question-answering system without making no process for estimating the answer type, the user can grasp the answer for the question sentence for each answer type, and easily obtain the correct answer.

Also, in the case where it is required that a plurality of question sentences regarding a certain item are given to the question-answering system, the answer for the plurality of answer types is outputted only by giving one question sentence to the question-answering system, whereby the user obtains the answer for each answer type by seeing the answer type corresponding to the question sentence, and the work labor and processing load in giving the plurality of question sentences are relieved.

Also, this invention provides the question-answering system for estimating the answer type of the answer for the question sentence, wherein for the predetermined answer type, the degree of confidence that the answer candidate is the answer type is calculated, the answer candidates are classified by answer type, and the answer table in table format listing the answer candidates for each of the answer types arranged in descending order of the degree of confidence is outputted.

Thereby, the question-answering system outputs the answers in clearly observable manner in descending order of the degree of confidence of the answer type confident as the answer. Hence, the user can directly obtain the answer of the answer type having the highest degree of confidence. Moreover, the user can easily refer to the answers of other answer types.

Also, this invention provides the question-answering system for inputting the answer type designated by the user, wherein the answer candidates are classified by answer type, and the answer table in the table format listing the answer candidates for each of the answer types arranged in the predetermined order with the input answer type at the beginning item is outputted.

Thereby, in the question-answering system, the answers are outputted in clearly observable manner with the input answer type as the beginning item. Hence, the user simply obtains the answer of the designated answer type, and easily refers to the answers of other answer types.

### BRIEF DESCRIPTION OF THE DRAWINGS

FIG. 1 is a diagram showing a configuration of a question-answering system according to a first embodiment of the invention;

FIG. 2 is a flowchart showing a processing flow of the question-answering system according to the first embodiment of the invention;

FIG. 3 is a table showing an example of an answer table for output;

FIG. 4 is a diagram showing a configuration of a question-answering system according to a second embodiment of the invention;

FIG. 5 is a flowchart showing a processing flow of the question-answering system according to the second embodiment of the invention;

FIG. 6 is a table showing an example of the answer table for output;

FIG. 7 is a table showing another example of the answer table for output;

FIG. 8 is a diagram showing a configuration of a question-answering system according to a third embodiment of the invention;

FIG. 9 is a flowchart showing a processing flow of the question-answering system according to the third embodiment of the invention;

FIG. 10 is a table showing an example of the answer table for output; and

FIG. 11 is a table showing another example of the answer table for output.

### DETAILED DESCRIPTION OF THE PREFERRED EMBODIMENTS

The preferred embodiments of the present invention will be described below.

As a first embodiment, there will be described the case in which the present invention is applied to a question-answering system that does not estimate the type of answer.

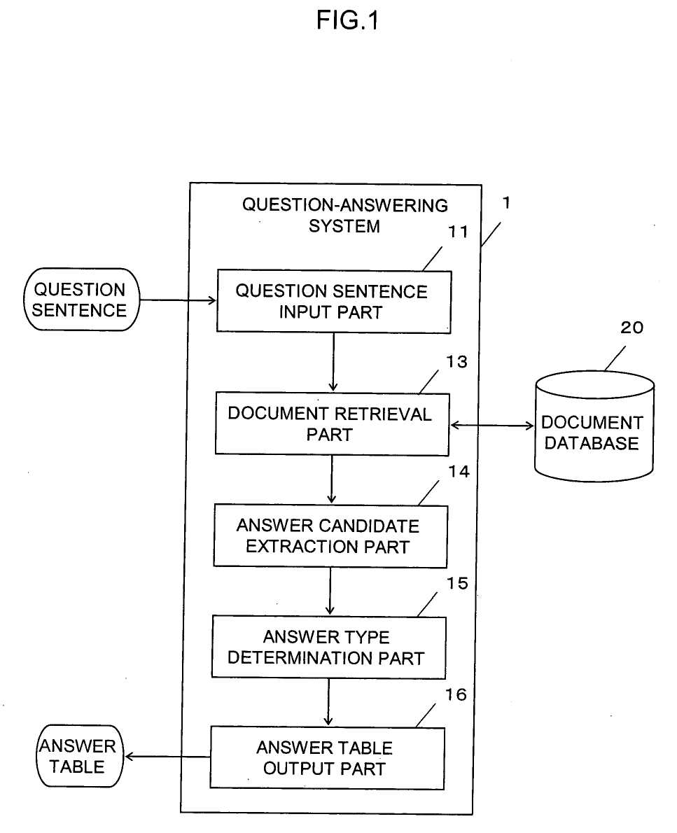

FIG. 1 is a diagram showing a configuration of a question-answering system according to a first embodiment of the invention. The question-answering system 1 comprises a question sentence input part 11, a document retrieval part 13, an answer candidate extraction part 14, an answer type determination part 15, an answer table output part 16, and a document database 20.

The question sentence input part 11 is means for inputting question sentence data (a question sentence) expressed in a natural language.

The document retrieval part 13 is means for retrieving and extracting the document data including a keyword, from the document database 20, that is searched for answer using a keyword extracted from a question sentence inputted by the question sentence input part 11. The document retrieval part 13 performs a retrieval process with a general known document retrieval method. For the document database 20, document data of news items, encyclopedia, English-Japanese dictionary and Web page is utilized.

The answer candidate extraction part 14 is means for extracting a language presentation possibly becoming the answer from the document data retrieved by the document retrieval part 13 and granting an evaluation point to the answer candidate. For example, the answer candidate extraction part 14 extracts the language presentation (answer candidate) possibly becoming the answer from the document data retrieved by the document retrieval part 13 to probabilistically evaluate the proximity between the answer candidate within the document data of extraction source and the keyword, and grant the evaluation point based on the proximity to the answer candidate.

The answer type determination part 15 is means for specifying a proper presentation of answer candidate through a proper presentation extracting process, and determining the answer type of answer candidate by referring to a predetermined answer type determination rule.

The proper presentation extracting process is the process for specifying the proper noun such as person's name, place name, organization name, or specific name (e.g., title of novel, name of prize), or the language presentation meaning a specific object or number such as a numerical presentation in terms of time, distance or amount of money. The answer type determination rule is the heuristic rule for determining the answer type corresponding to the language presentation (answer candidate) extracted through the proper presentation extracting process.

The answer table output part 16 is means for classifying the answer candidates extracted by the answer candidate extraction part 14 according to the answer types, extracting the answer candidate of predetermined evaluation as the answer from among the answer candidates for each answer type, and creating and outputting the table data (answer table) listing the extracted answers for each answer type in table format.

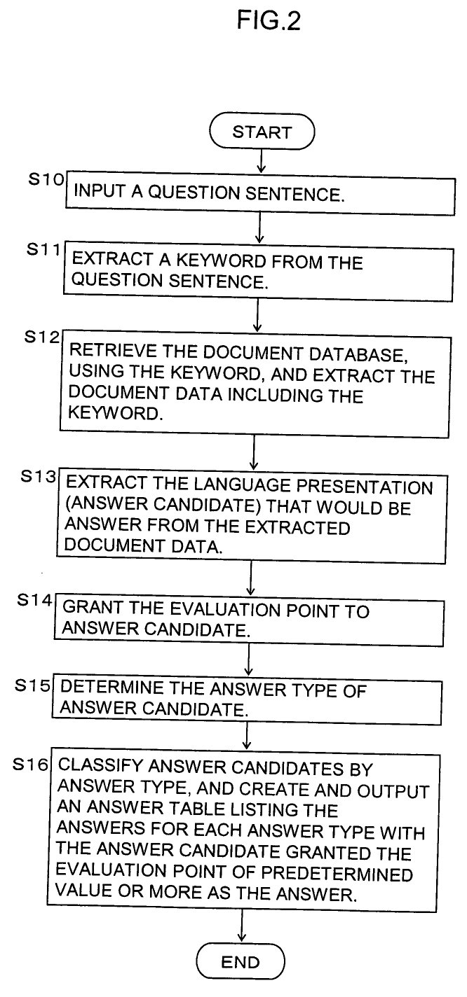

FIG. 2 is a flowchart showing a process flow of the question-answering system according to the first embodiment of the invention.

The question sentence input part 11 of the question-answering system 1 inputs a question sentence (step S10). And the document retrieval part 13 extracts a keyword from the question sentence (step S11), retrieves the document database 20, using the extracted keyword, and extracts the document data including the keyword (step S12). Specifically, in a case that the question sentence “Where is the capital of Japan?” is input, the document retrieval part 13 segments the nouns “Japan, capital” from the question sentence by making the morphological analysis for the question sentence and makes them the keyword. And the document data including the keywords “Japan, capital” is extracted by retrieving the document database 20, using the keywords “Japan, capital”. As a result of retrieval, the following document data is extracted and the answer for the question sentence is extracted.

“In the year 1999, an international conference A is held for the first time by B institute in Tokyo, capital of Japan. Participation of about 80 persons is expected. Mr. C of previous president showed appreciation for efforts of Mr. D of current president.”

Then, the answer candidate extraction part 14 extracts the language presentation (answer candidate) possibly becoming the answer from the extracted document data (step S13). The answer candidate extraction part 14 extracts the language presentation such as noun or noun phrase generated by segmenting a character string of n-gram from the extracted document data.

“Year 1999, Tokyo, international conference A, B institute, about 800 persons, participation, previous president, Mr. C, current president, Mr. D, efforts”

Moreover, the answer candidate extraction part 14 grants an evaluation point to each answer candidate (step S14). The answer candidate extraction part 14 determines the proximity at the appearance location between the extracted answer candidate and the keyword in the extracted document data and calculates the evaluation point employing a predetermined expression of granting higher evaluation as the answer candidate and the keyword appear in more proximity. Herein, as the answer candidate and the keyword appear in narrower range in the document data, the answer candidate and the keyword have higher relevance, on the presumption that the answer candidate having higher relevance with the keyword is more excellent as the answer for the question sentence.

The answer type determination part 15 determines the answer type of answer candidate by referring to the answer type determination rule (step S15). The answer type determination part 15 specifies the proper presentation of noun or noun phrase such as person's name, place name, or numerical presentation through the proper presentation extracting process, and determines the answer type of answer candidate by referring to the following answer type determination rule based on the specified proper presentation.

(1) If the proper presentation of answer candidate is “person's name”, the answer type is “person's name”;

(2) If the proper presentation of answer candidate is “a place name”, the answer type is “place name”;

(3) If the proper presentation of answer candidate is “a specifically named thing”, the answer type is “specific name”;

(4) If the proper presentation of answer candidate is “a noun indicating the time”, the answer type is “time”;

(5) If the proper presentation of answer candidate is “a noun indicating the numerical value”, the answer type is “numerical presentation”; and

(6) If the proper presentation of answer candidate does not conform to any of the above items (1) to (5), the answer type is “others”.

For example, if the proper presentation of answer candidate “year 1999” is specified as “time”, the answer type is determined as “time, numerical presentation” according to answer type determination rule (4). Also, if the proper presentation of answer candidate “Tokyo” is specified as “place name”, the answer type is determined as “place name” according to answer type determination rule (2).

The answer type determination part 15 may extract the part of speech phrase (verb phrase, adjective phrase, etc.) other than the noun phrase as the proper presentation extracting process.

Then, the answer table output part 16 classifies the answer candidates by answer type, and creates and outputs an answer table listing the answers for each answer type with the answer candidate granted the evaluation point of a predetermined value or more as the answer (step S16). The answer table output part 16 arranges the answer types as the heading item in predetermined order, and creates the answer table in which the answers are arranged for each item of answer types in descending order of evaluation point.

The answer candidates are classified according to the following answer types, and the selected answers having certain evaluation points are rearranged for each answer type in descending order of evaluation point.

Person's name: Mr. C, Mr. D;

Place name: Tokyo;

Organization name: B institute;

Time: year 1999;

Specific name: international conference A;

Numerical presentation: year 1999, about 800 persons; and

Others: participation, previous president, current president, efforts

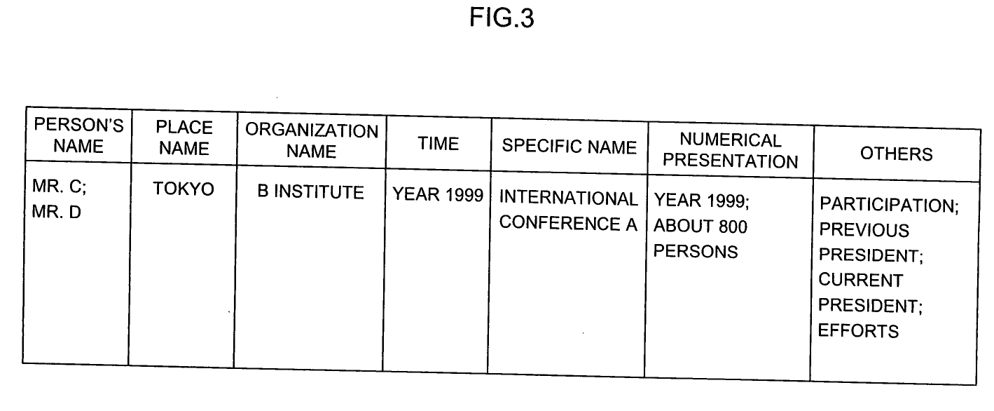

FIG. 3 shows an example of the output answer table. In the answer table as shown in FIG. 3, the items of answer type are arranged in predetermined order, and the answers are arranged for each answer type in descending order of evaluation point from the beginning. The user who knows that the answer type is “place name” sees the item “place name” of answer type in the answer table, and understands at once that the answer is “Tokyo”.

As shown in this example, according to this invention, the answers can be outputted in table format for each answer type in the question-answering system performing no process for estimating the answer type from the question sentence. Thereby, the user easily obtains the correct answer by referring to the corresponding item of answer type from the answer table.

When the user wants to get the answers for a plurality of answer types regarding the relevant item, the user can get the answers for the plurality of answer types at once only by giving one question sentence to the question-answering system. For example, suppose that the user wants to get the answer by inputting the following question sentences in succession.

Question sentence Q1: “Where the international conference A was held?”

Question sentence Q2: “When the international conference A was held?”

Question sentence Q3: “Which institute the international conference A was held by?”

According to this invention, if the question sentence Q1 is inputted, the question-answering system 1 performs the above process, acquires the answer for the question sentence Q1 and the answers for other answer types the same time, and outputs the answer table, as shown in FIG. 3. The user knowing the answer types for the question sentences Q1 to Q3 sees the answer table of FIG. 3, and knows the answers corresponding to three question sentences, including answer “Tokyo” for the question sentence Q1, answer “year 1999” for the question sentence Q2, and answer “B institute” for the question sentence Q3.

A question-answering system for estimating the answer type for the answer according to a second embodiment of the invention will be described below.

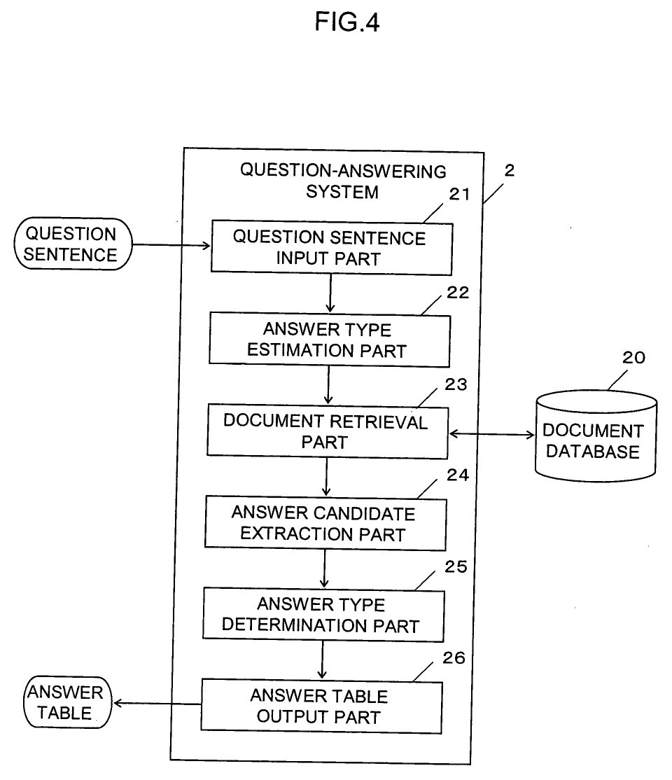

FIG. 4 is a diagram showing a configuration of the question-answering system according to the second embodiment of the invention. The question-answering system 2 comprises a question sentence input part 21, an answer type estimation part 22, a document retrieval part 23, an answer candidate extraction part 24, an answer type determination part 25, an answer table output part 26, and a document database 20.

The question sentence input part 21, the document retrieval part 23, the answer candidate extraction part 24, the answer type determination part 25, and the answer table output part 26 are processing means for performing the same processes as the question sentence input part 11, the document retrieval part 13, the answer candidate extraction part 14, the answer type determination part 15, and the answer table output part 16 of the question-answering system 1.

The answer type estimation part 22 is means for estimating the certainty (degree of confidence) for a predetermined answer type that the answer is of the answer type from the input question sentence, employing a machine learning method based on the probability and capable of calculating the numerical value that can be ranked.

The answer type estimation part 22 employs a maximum entropy method as the machine learning method based on the probability. The maximum entropy method is the processing method for acquiring a probability distribution of which the entropy is maximum under the condition that the expected value of appearance of origin that is a minute unit of information useful for estimation in the learning data and the expected value of appearance of origin in the unknown data are equal, calculating a probability of each class for each appearance pattern of origin based on the acquired probability distribution, and acquiring the class having the maximum probability as the answer type to be obtained.

With the maximum entropy method, the certainty of predetermined answer type is calculated in the probability value, whereby the order of displaying the answer types is decided based on the calculated probability value.

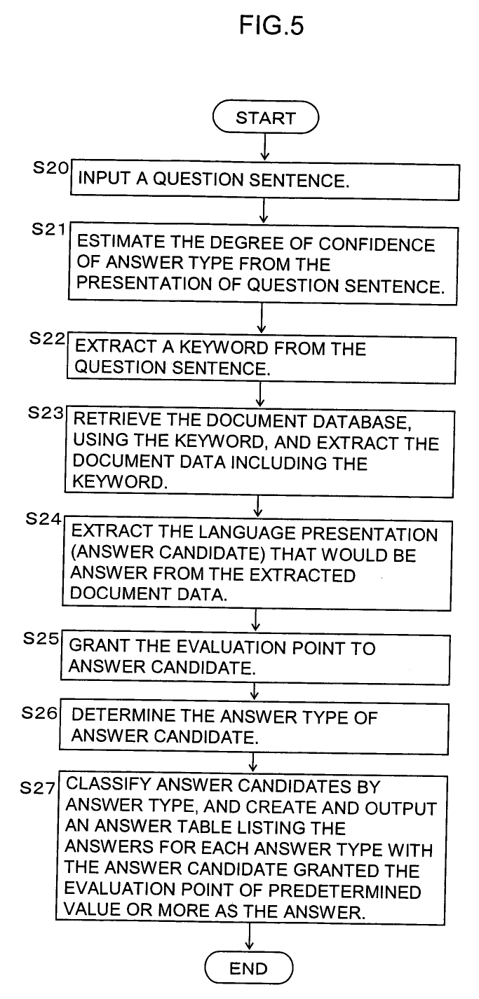

FIG. 5 is a flowchart showing a process flow of the question-answering system according to the second embodiment of the invention.

The question sentence input part 21 of the question-answering system 2 inputs a question sentence (step S20). Then, the answer type estimation part 22 estimates the degree of confidence of the answer type from the presentation of question sentence through an estimation process using the mechanical learning method (step S21). The answer type estimation part 22 makes the morphological analysis for the input question sentence, and estimates the answer type of the answer for the question sentence, using the mechanical learning method such as the maximum entropy method, with the presentation of analyzed interrogative pronoun as the clue. For example, when the input question sentence is “Where is the capital of Japan?”, the answer type is estimated to be the “place name”, with the presentation of “Where” in the question sentence as the clue.

And the document retrieval part 23 extracts a keyword from the question sentence (step S22), retrieves the document database 20, using the extracted keyword, and extracts the document data including the keyword (step S23). The answer candidate extraction part 24 extracts the language presentation (answer candidate) possibly becoming the answer from the extracted document data (step S24). Moreover, the answer candidate extraction part 24 determines the proximity at appearance location between the extracted answer candidate in the extracted document data and the keyword, and grants the evaluation point to the answer candidate (step S25). And the answer type determination part 25 determines the answer type of answer candidate by referring to the predetermined answer type determination rule (step S26).

Thereafter, the answer table output part 26 classifies the answer candidates by answer type, and creates and outputs an answer table listing the answers for each answer type with the answer candidate granted the evaluation point of a predetermined value or more as the answer (step S27). The answer table output part 26 arranges the answer types as the heading item in descending order of the degree of confidence, and creates the answer table in which the answers are arranged for each item of answer types in descending order of evaluation point.

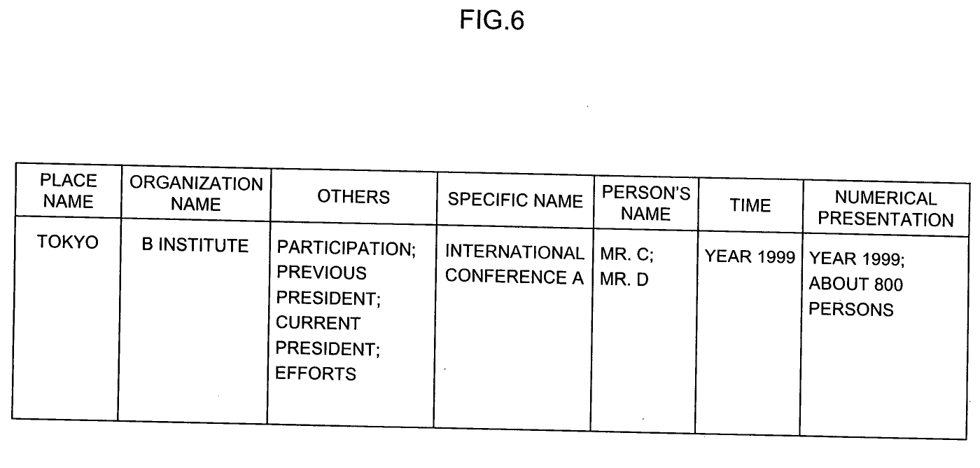

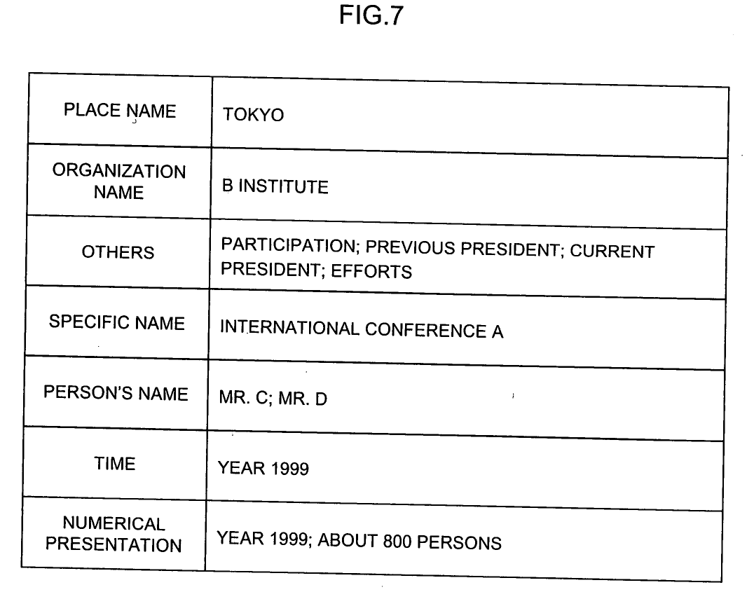

FIGS. 6 and 7 each show an example of the output answer table. In the answer table as shown in FIG. 6, the items of answer type are arranged from the beginning (left) in descending order of the degree of confidence as estimated at step S21, such as “place name, organization name, others, specific name, . . . ”. Also, the answers classified by answer type are arranged for each answer type in descending order of evaluation point from the beginning.

Also, the items of answer type are arranged from the beginning (top) in descending order of the degree of confidence as estimated in the same way as in FIG. 6, such as “place name, organization name, others, specific name, . . . ”, as shown in FIG. 7.

Also, the answer table output part 26 may display the degree of confidence as calculated in the answer type estimation part 22 such as “X%” within the items of answer type of FIGS. 6 and 7.

In this embodiment, the user can find the correct answer by referring to the answer table outputted in the question-answering system in which the items of answer type are arranged in descending order of certainty. Moreover, even when the question-answering system fails to estimate the answer type, the user can select the correct answer from the answer table, because all the answers of answer types are listed in the answer table.

A question-answering system for inputting the answer type for the answer according to a third embodiment of the invention will be described below.

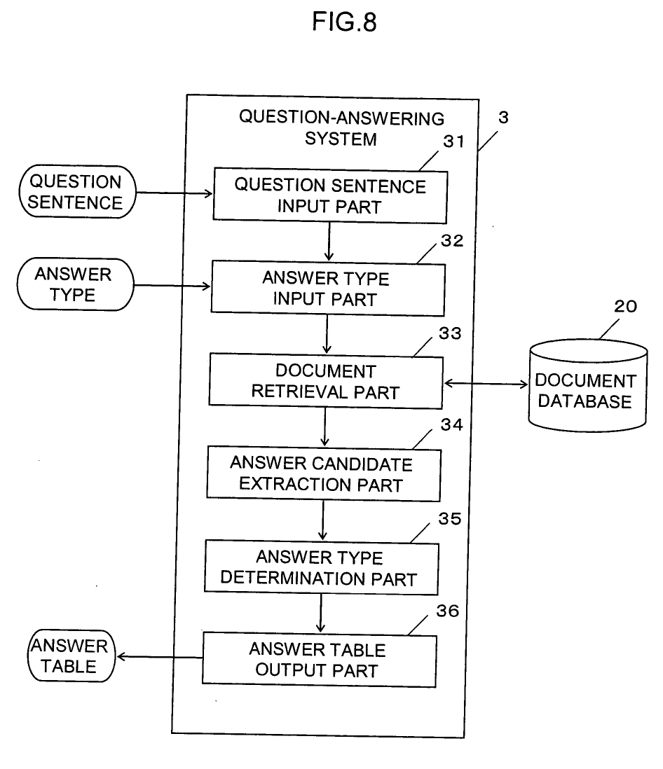

FIG. 8 is a diagram showing a configuration of the question-answering system according to the third embodiment of the invention. The question-answering system 3 comprises a question sentence input part 31, an answer type input part 32, a document retrieval part 33, an answer candidate extraction part 34, an answer type determination part 35, an answer table output part 36, and a document database 20.

The question sentence input part 31, the document retrieval part 33, the answer candidate extraction part 34, the answer type determination part 35, and the answer table output part 36 are processing means for performing the same processes as the question sentence input part 11, the document retrieval part 13, the answer candidate extraction part 14, the answer type determination part 15, and the answer table output part 16 of the question-answering system 1.

The answer type input part 32 is means for inputting the answer type that the user selects or instructs for input.

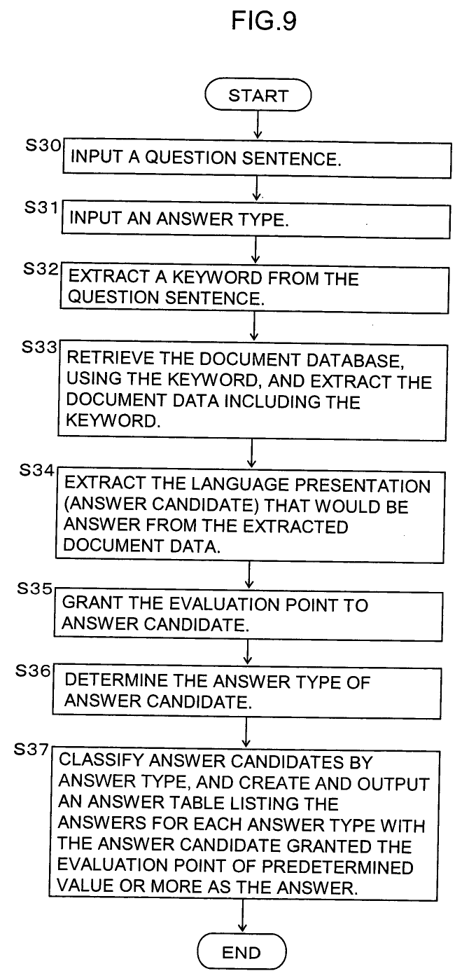

FIG. 9 is a flowchart showing a process flow of the question-answering system according to the third embodiment of the invention.

The question sentence input part 31 of the question-answering system 3 inputs a question sentence (step S30). Then, the answer type input part 32 inputs the answer type (step S31). Herein, it is supposed that the input answer type is “place name”.

And the document retrieval part 33 extracts a keyword from the question sentence (step S32), retrieves the document database 20, using the extracted keyword, and extracts the document data including the keyword (step S33). The answer candidate extraction part 34 extracts the language presentation (answer candidate) possibly becoming the answer from the extracted document data (step S34). Moreover, the answer candidate extraction part 34 determines the proximity at appearance location between the extracted answer candidate in the extracted document data and the keyword, and grants the evaluation point to the answer candidate (step S35). Also, the answer type determination part 35 determines the answer type of answer candidate by referring to the predetermined answer type determination rule (step S36).

Then, the answer table output part 36 classifies the answer candidates by answer type, and creates and outputs an answer table listing the answers for each answer type with the answer candidate granted the evaluation point of a predetermined value or more as the answer (step S37). The answer table output part 36 arranges the input answer type as the heading item at the beginning, and subsequently the answer types other than the input answer type in the predetermined order, and creates the answer table in which the answers are arranged in descending order of evaluation point for each item of answer types.

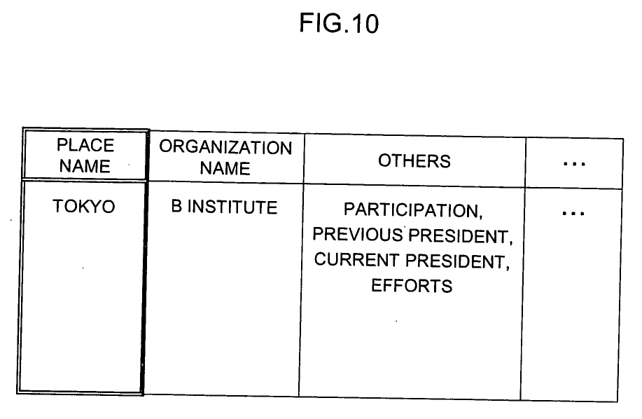

FIG. 10 shows an example of the output answer table. In the answer table as shown in FIG. 10, the input answer type “place name” is arranged at the beginning (leftmost), and the answer types other than the input answer type are subsequently arranged in the predetermined order. Also, the answers classified by answer type are arranged for each answer type in descending order of evaluation point from the beginning.

Thereby, the user can surely find the answer of input answer type in the answer table outputted in the question-answering system, and easily refer to the answers of other answer types. Also, the question-answering system 3 performing no process for estimating the answer type attains the higher processing accuracy than the question-answering system for performing the process for estimating the answer type.

Though in the above embodiments 1 to 3, the pattern of language presentation possibly becoming the answer is pattern (answer type) based on the meaning of language presentation such as place name, person's name or specific name, the answer presentation type may be employed, instead of the answer type. The answer presentation type is the pattern based on the notation of language presentation possibly becoming the answer. The answer presentation types such as “presentation of hiragana, presentation of katakana, presentation of kanji, presentation of English letter, presentation of English symbol and number, presentation of kanji and katakana, and presentation including numerical presentation” are defined beforehand.

In this case, the answer candidate extraction parts 14, 24 and 34 extract the answer candidate using the kind of character (hiragana, katakana, kanji, English letter, etc.) of the character string within the retrieved document data. And the answer type determination parts 15, 25 and 35 determine the answer presentation type from the kind of character of the answer candidate.

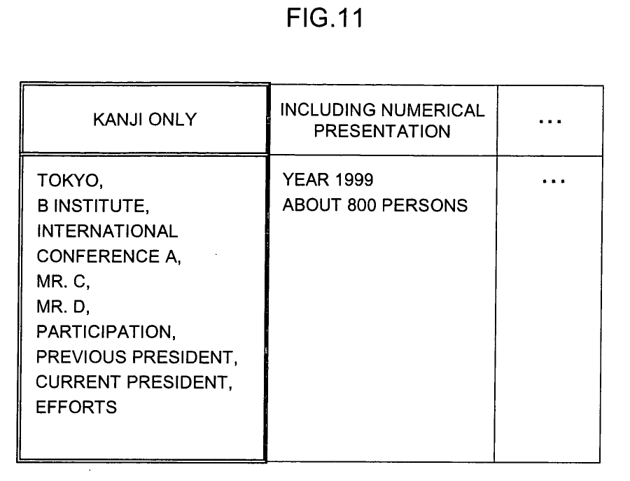

FIG. 11 shows an example of the output answer table. In the answer table as shown in FIG. 11, the answer presentation types “kanji alone, including the numerical presentation, etc.” are arranged. Also, the answers classified by answer type are arranged for each answer type in descending order of evaluation point from the beginning. When the degree of confidence of the answer presentation type is estimated, the answer presentation types are arranged in the order in which the degree of confidence is estimated.

Through in the above embodiments 1 to 3, the answer table output parts 16, 26 and 36 may create the answer table in which the items of answer type having no answer candidate are omitted.

Particularly in the second embodiment, the answer table output part 26 may create the answer table listing the items of answer type in which the degree of confidence of the answer type calculated in the answer type estimation part 22 is greater than or equal to a predetermined evaluation point, or the answer table listing a predetermined number of items of answer type in descending order of the degree of confidence of the answer type.

Though the embodiments of the invention have been described above, it is obvious that various modifications may be made without departing from the spirit or scope of the invention.

For example, in the first to third embodiments of the invention, the question-answering system 1, 2 and 3 consist of the answer type determination parts 15, 25 and 35 for determining the answer type by referring to predetermined heuristic answer type determination rules.

However, the question-answering systems 1, 2 and 3 may comprise of the answer type determinations parts 15′, 25′ and 35′ for estimating or determining the answer type, employing the machine learning method with teacher such as maximum entropy method or support vector machine method, instead of making the process employing the heuristic rules.

In this case, the answer type determination parts 15′, 25′ and 35′ prepare the patterns in which the correct input (language presentation) and output (answer type for determination) for each question are paired as the learning data, the patterns being produced by the user, and learn which answer type is most likely to occur in case of each language presentation. And the answer type for the extracted language presentation (answer candidate) is determined.

The support vector machine method involves classifying the data into two classes by dividing the space with hyper-plane, in which on the presumption that there is lower possibility that the unknown data is classified falsely as the interval (margin) between a group of instances of two classes in the learning data and the hyper-plane is greater, the hyper-plane for maximizing the margin is obtained to classify the data. When the data is classified into three or more classes, a plurality of support vector machines are combined.

Also, in the question-answering system 2, the answer type estimation part 22 may be processing means for performing the process employing the heuristic answer type estimation rules defining the correspondence relation between the question sentence and the answer type of the answer. In this case, the degree of confidence indicating which answer type is for which question sentence is defined in the answer type estimation rules, employing the correspondence relation between the question sentence and the answer type of the answer and the “if then” rule.

Also, this invention may be implemented as a processing program that is read and executed by the computer. Also, the processing program that implements the invention may be stored in an appropriate recording medium such as a portable medium memory, a semiconductor memory or a hard disk, and provided by being stored in the recording medium, or distributed via a communication interface across various communication networks.

1. A question-answering system for inputting the question sentence data presented in a natural language and outputting an answer for the question sentence data from a group of document data to be retrieved for the answer, the system comprising:
document retrieval means for extracting a keyword from the input question sentence data and retrieving and extracting the document data including the keyword from the group of document data;
answer candidate extracting means for extracting a language presentation possibly becoming the answer as an answer candidate from the document data;
answer type determination means for storing predetermined answer types for classifying the answer candidates and determining of which answer type the answer candidate is; and
answer table output means for classifying the answer candidates by answer type, and outputting the answer table data in a table format in which all or part of the answer candidates are arranged with the answer type as a heading item for each the answer type.

2. The question-answering system according to claim 1, further comprising answer type estimation means for analyzing the language presentation of the question sentence data and estimating a degree of confidence that the answer for the question sentence data is predetermined answer type, wherein the answer table output means creates the answer table data in which the answer types are arranged in descending order of the degree of confidence.

3. The question-answering system according to claim 1, wherein the answer table output means creates the answer table data in which the answer types are arranged in descending order of the degree of confidence and listing the degree of confidence of the answer type.

4. The question-answering system according to claim 1, wherein the question type determination means stores the answer type indicating a meaning pattern for the language presentation of answer candidate as the answer type, and determines the answer type of the answer candidate.

5. The question-answering system according to claim 1, wherein the answer type determination means stores the answer presentation type indicating an inscribed pattern for the language presentation of answer candidate as the answer type, and determines the answer type of the answer candidate.

6. A question-answering system for inputting the question sentence data presented in a natural language and outputting an answer for the question sentence data that is retrieved from a group of document data of retrieval subject, the system comprising:
answer type input means for inputting an answer type of the answer for the question sentence data;
document retrieval means for extracting a keyword from the input question sentence data and retrieving and extracting the document data including the keyword from the group of document data;
answer candidate extracting means for extracting a language presentation possibly becoming the answer as an answer candidate from the document data;
answer type determination means for storing predetermined answer types for classifying the answer candidates and determining of which answer type the answer candidate is; and
answer table output means for classifying the answer candidates by answer type, and outputting the answer table data in a table format in which all or part of the answer candidates are arranged with the answer type as a heading item for each the answer type and the input answer type is a beginning item.

7. The question-answering system according to claim 6, wherein the question type determination means stores the answer type indicating a meaning pattern for the language presentation of answer candidate as the answer type, and determines the answer type of the answer candidate.

8. The question-answering system according to claim 6, wherein the answer type determination means stores the answer presentation type indicating an inscribed pattern for the language presentation of answer candidate as the answer type, and determines the answer type of the answer candidate.

9. A question-answering processing method for inputting the question sentence data presented in a natural language and outputting an answer for the question sentence data from a group of document data to be retrieved for the answer, the method comprising:
a document retrieval processing step of extracting a keyword from input document sentence data and retrieving and extracting the document data including the keyword from the group of document data;
an answer candidate extraction processing step of extracting a language presentation possibly becoming the answer as an answer candidate from the document data;
an answer type determination processing step of storing predetermined answer types for classifying the answer candidates and determining of which answer type the answer candidate is; and
an answer table output processing step of classifying the answer candidates by answer type, and outputting the answer table data in a table format in which all or part of the answer candidates are arranged with the answer type as a heading item for each the answer type.

10. The question-answering processing method according to claim 9, further comprising an answer type estimation processing step of analyzing the language presentation of the question sentence data and estimating a degree of confidence that the answer for the question sentence data is predetermined answer type, wherein the answer table output processing step comprises creating the answer table data in which the answer types are arranged in descending order of the degree of confidence.

11. The question-answering processing method according to claim 9, wherein the answer table output processing step comprises creating the answer table data in which the answer types are arranged in descending order of the degree of confidence and listing the degree of confidence of the answer type.

12. The question-answering processing method according to claim 9, wherein the question type determination means stores the answer type indicating a meaning pattern for the language presentation of answer candidate as the answer type, and determines the answer type of the answer candidate.

13. The question-answering processing method according to claim 9, wherein the answer type determination processing step comprises storing the answer type indicating an inscribed pattern for the language presentation of answer candidate as the answer type, and determines the answer type of the answer candidate.

14. A question-answering processing method for inputting the question sentence data presented in a natural language and outputting an answer for the question sentence data from a group of document data to be retrieved for the answer, the method comprising:
an answer type input processing step of inputting an answer type of the answer for the question sentence data;
a document retrieval processing step of extracting a keyword from the input question sentence data and retrieving and extracting the document data including the keyword from the group of document data;
an answer candidate extraction processing step of extracting a language presentation possibly becoming the answer as an answer candidate from the document data;
an answer type determination processing step of storing predetermined answer types for classifying the answer candidates and determining of which answer type the answer candidate is; and
an answer table output processing step of classifying the answer candidates by answer type, and outputting the answer table data in a table format in which all or part of the answer candidates are arranged with the answer type as a heading item for each the answer type and the input answer type is a beginning item.

15. The question-answering processing method according to claim 14, wherein the question type determination means stores the answer type indicating a meaning pattern for the language presentation of answer candidate as the answer type, and determines the answer type of the answer candidate.

16. The question-answering processing method according to claim 14, wherein the answer type determination processing step comprises storing the answer type indicating an inscribed pattern for the language presentation of answer candidate as the answer type, and determines the answer type of the answer candidate.
